(19) United States
(12) Patent Application Publication
(10) Pub. No.: US 2008/0011335 A1
(43) Pub. Date: Jan. 17, 2008

(54) Dish washing machine

(75) Inventors: Eui Soo Kim, Suweon-si (KR); Yong Woon Han, Gunpo-si (KR); Young Ho Kwon, Seognam-si (KR); Shimotera Kennichi, Seoul (KR); Sung Jin Kim, Suweon-si (KR); Jung Chan Ryu, Suwon-si (KR); Jae Young Choi, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co. LTD., Suwon-Si (KR)

(21) Appl. No.: 11/806,519

(22) Filed: May 31, 2007

(30) Foreign Application Priority Data
Jul. 12, 2006 (KR) 10-2006-0065595

(51) Int. Cl. B08B 3/10

(52) U.S. Cl. 134/104.4; 134/105; 134/113; 134/186

(57) ABSTRACT

A dish washing machine capable of smoothly discharging dirt contained in wash water out of a sump so as to prevent the emission of bad smells from the dirt and prevent the propagation of bacteria. The dish washing machine includes a sump to receive and pump wash water, a sump housing forming an external appearance of the sump, a drainage pump coupled with the sump housing to discharge wash water and dirt, and a drainage channel disposed in the sump housing to guide wash water and dirt to the drainage pump.

### CROSS-REFERENCE TO RELATED APPLICATIONS

This application claims the benefit of Korean Patent Application No. 10-2006-0065595, filed on Jul. 12, 2006 in the Korean Intellectual Property Office, the disclosure of which is incorporated herein by reference.

### BACKGROUND OF THE INVENTION

1. Field of the Invention

The present invention relates to a dish washing machine. More particularly, to a dish washing machine capable of improving spatial utilization of a washing tub through the enlargement of the washing tub and controlling the amount of wash water based on the quantity of dishes at the time of washing the dishes.

2. Description of the Related Art

A conventional dish washing machine is a machine that automatically washes dishes using cold water or hot water. A conventional dish washing machine includes a machine body, a washing tub formed in the machine body, baskets mounted in the washing tub, and main, middle, and sub nozzles mounted at the upper part, the middle part, and the lower part of the washing tub to inject wash water, which is disclosed in Korean Unexamined Patent Publication No. 2006-27096.

At the bottom of the washing tub is mounted a sump to receive wash water and pump the wash water to the respective nozzles. The sump includes a sump housing forming the external appearance of the sump, a heater mounted in the sump housing, a washing impeller disposed in the sump housing to pump wash water, a channel to guide the wash water pumped from the washing impeller to the respective nozzles, a channel control valve mounted in the channel to control the flow of wash water, and a pump motor mounted at the outside of the sump housing to drive the washing impeller.

In the sump housing is disposed a heater receiving part, which is formed in the shape of a square pool. The heater is received in the heater receiving part. At the outside of the sump housing is disposed a drainage pump, which communicates with the heater receiving part.

When dirt mixed with wash water is left in the heater receiving part, the drainage pump is operated such that the dirt and the wash water are discharged to the outside. However, the bottom of the heater receiving part is flat, and the dirt is caught by the heater. As a result, it is difficult to completely discharge the dirt.

When dirt is left in the heater receiving part due to the structural problems of the heater and the heater receiving part, bad smells are emitted from the dirt and bacteria propagate, which are great sanitary problems.

### SUMMARY OF THE INVENTION

Accordingly, it is an aspect of the present invention to provide a dish washing machine capable of smoothly discharging wash water and dirt contained in the wash water so as to prevent an emission of bad smells from the dirt or the wash water and to prevent the propagation of bacteria.

Additional aspects and/or advantages of the invention will be set forth in part in the description which follows and, in part, will be apparent from the description, or may be learned by practice of the invention.

The foregoing and/or other aspects of the present invention are achieved by providing a dish washing machine including a sumpto receive and pump wash water, a sump housing forming an external appearance of the sump, a drainage pump coupled with the sump housing to discharge wash water and dirt, and a drainage channel disposed in the sump housing to guide wash water and dirt to the drainage pump.

According to an aspect of the present invention, the drainage channel is inclined along an inner edge of the sump housing and communicates with the drainage pump.

The sump housing includes a pump motor receiving part to receive a pump motor to drive a washing impeller that pumps wash water, and the drainage channel includes first and second drainage channels formed around the pump motor receiving part and a third drainage channel connected between the first and second drainage channels, the third drainage channel communicating with the drainage pump.

The first and second drainage channels have surfaces inclined downward to the third drainage channel such that drainage is smoothly performed along the downward-inclined surfaces.

According to an aspect of the present invention, a bottom surface of the drainage channel is lower than a top surface of the pump motor receiving part.

According to an aspect of the present invention, the sump housing is formed in a shape of a container, the pump motor receiving part is disposed in a center of the sump housing, the drainage channel is disposed between the pump motor receiving part and a rim wall of the sump housing, and the drainage channel is located below a top surface of the pump motor receiving part and in a shape surrounding the pump motor receiving part.

The drainage channel includes a turbidity sensor to detect the turbidity of wash water mounted therein.

It is another aspect of the present invention to provide a dish washing machine including a sump to receive and pump wash water, a sump housing forming an external appearance of the sump, a drainage pump mounted at the sump housing to discharge wash water and dirt from the sump housing, and a drainage channel communicating with the drainage pump to guide wash water and dirt to the drainage pump, wherein the drainage channel extends along an inner edge of the sump housing.

The sump housing includes a pump motor receiving part to receive a pump motor to drive a washing impeller which pumps wash water, and the drainage channel includes first and second drainage channels surrounding an edge of the pump motor receiving part and a third drainage channel connected between the first and second drainage channels and communicating with the drainage pump, the first and second drainage channels having surfaces inclined downward to the third drainage channel such that drainage is smoothly performed along the downward-inclined surfaces.

The third drainage channel includes a drainage pump connection hole connected to the drainage pump.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a side sectional view of a dish washing machine according to an embodiment of the present invention;

FIG. 2 is a perspective view illustrating an interior of a machine body of the dish washing machine according to an embodiment of the present invention;

FIG. 3 is an exploded perspective view of a sump according to an embodiment of the present invention;

FIG. 4 is a perspective view of a drainage channel according to an embodiment of the present invention;

FIG. 5 is a sectional view taken along line I-I′ of FIG. 4;

FIG. 6 is a sectional view taken along line II-II′ of FIG. 4;

FIG. 7 is a sectional view taken along line III-III′ of FIG. 4;

FIGS. 8 and 12 are assembled perspective views of the sump, according to an embodiment of the present invention;

FIG. 9 is a perspective view of a sump housing according to an embodiment of the present invention;

FIG. 10 is an assembled perspective view of the sump housing and an impeller casing according to an embodiment of the present invention; and

FIG. 11 is a perspective view illustrating an impeller casing cover coupled to the sump housing, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below to explain the present invention by referring to the figures.

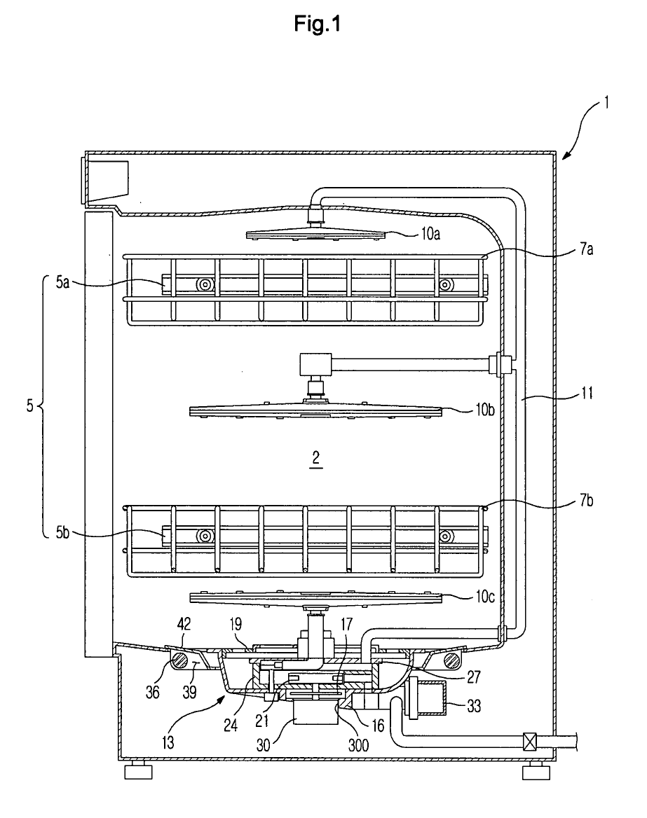

As shown in FIG. 1, the dish washing machine according to an embodiment of the present invention, comprises a machine body 1 forming an external appearance of the dish washing machine, a washing tub 2 disposed in the machine body 1, and a rack 5 fixed to a sidewall of the washing tub 2. The rack 5 comprises an upper rack 5a and a lower rack 5b, by which an upper basket 7a and a lower basket 7b are supported, respectively. Dishes are placed in the upper basket 7a and the lower basket 7b.

At the upper part, the middle part, and the lower part of the washing tub 2 are mounted main nozzles 10a and 10b and a sub nozzle 10c, respectively, to inject wash water. The wash water injected through the nozzles 10a, 10b and 10c is directed toward the baskets 7a and 7b. The nozzles 10a, 10b and 10c are rotated by the injection pressure of the wash water injected through the nozzles 10a, 10b and 10c. The wash water injected through the nozzles 10a, 10b, and 10c collides with the dishes in the baskets 7a and 7b to strongly wash the dishes.

A sump 13 is mounted at the bottom of the washing tub 2 to receive, pump, and supply wash water to the respective nozzles.

At the rear of the washing tub 2 is disposed a feeding pipe 11 to supply wash water to the main nozzles 10a and 10b. The lower end of the feeding pipe 11 is connected to the sump 13. Consequently, the wash water flows to the main nozzles 10a and 10b through the feeding pipe 11 due to strong pumping pressure of the sump 13.

The sub nozzle 10c is directly connected with an upper center part of the sump 13. Consequently, some of the wash water is injected through the sub nozzle 10c to wash dishes placed in the lower basket 7b adjacent to the sub nozzle 10c.

When the quantity of dishes is relatively small, the dishes may be placed only in the upper basket 7a, and wash water is injected only through the main nozzles 10a and 10b while the wash water is not injected through the sub nozzle 10c.

The sump 13 comprises a sump housing 16 forming an external appearance of the sump, a sump cover 19 to cover the sump housing 16, a washing impeller 21 disposed in the sump housing 16, an impeller casing 24 to which the washing impeller 21 is mounted, and an impeller casing cover 27 disposed on the impeller casing 24.

At a bottom of the sump housing 16 is mounted a pump motor 30 to drive the washing impeller 21. In addition, a pump motor receiving part 300 is disposed at the bottom of the sump housing 16 such that the pump motor 30 is received in the pump motor receiving part 300.

Around the pump motor receiving part 300 is disposed a drainage channel (to be described later), to guide wash water and dirt discharged from the sump housing 16.

A drainage pump 33 is mounted at a side of the sump housing 16 to discharge wash water and dirt in the sump 13 out of the dish washing machine.

A heater 36 is mounted at an edge of the sump 13 to heat wash water. A heater receiving groove 39 is formed at the bottom of the washing tub 2, and extends along an edge of the sump 13 such that the heater 36 is received in the heater receiving groove 39.

After the heater 36 is received in the heater receiving groove 39, the heater 36 is covered by a heater cover 42 to prevent the heater 36 from being exposed to the outside.

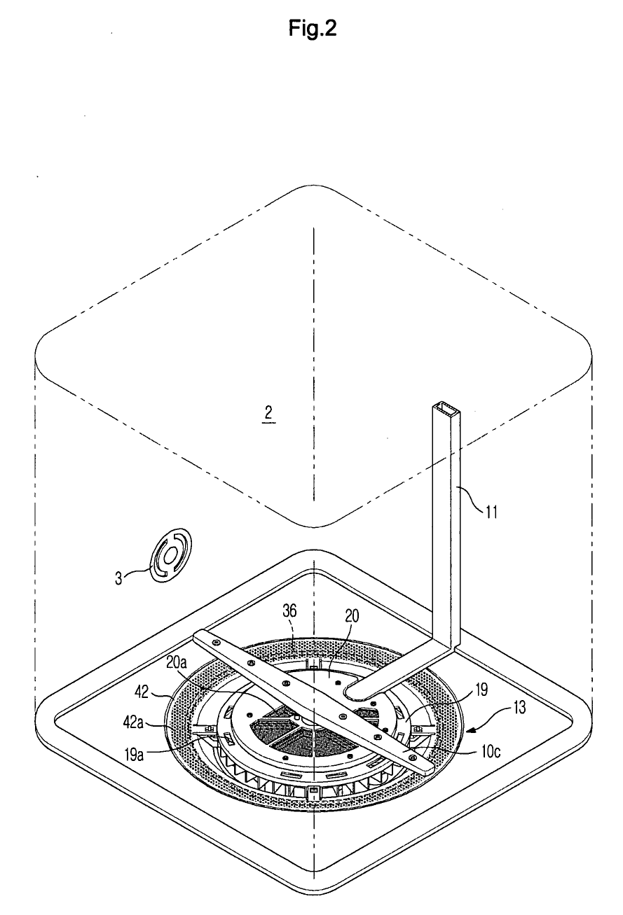

As shown in FIG. 2, an inlet port 3 is formed through one side of the washing tub 2 such that wash water can be introduced into the washing tub 2 through the inlet port 3. Wash water introduced through the inlet port 3 falls to the bottom of the washing tub 2 and is introduced into the sump 13.

The sub nozzle 10c is rotatably coupled with a center of the sump 13. The feeding pipe 11 is connected with a rear end of the sump 13 such that wash water is guided to the main nozzles 10a and 10b through the feeding pipe 11.

The sump cover 19 is mounted on the sump 13. Inlet holes 19a are formed along an edge of the sump cover 19 and are arranged in regular intervals. Consequently, wash water is introduced into the sump 13 through the inlet holes 19a.

On the sump cover 19 is mounted a filter cover 20. A mesh filter 20a is mounted to the filter cover 20 to prevent dirt collected in a filth chamber (to be described later), from overflowing from the filth chamber and to allow only wash water to flow out of the filth chamber.

The heater 36 is mounted at the edge of the sump 13 in the shape of a ring, for example. The heater cover 42 is mounted on the heater 13. The heater cover 42 comprises a plurality of through-holes 42a, through which wash water flows to the heater 36. The wash water is heated by the heater 36, and is then introduced into the sump 13.

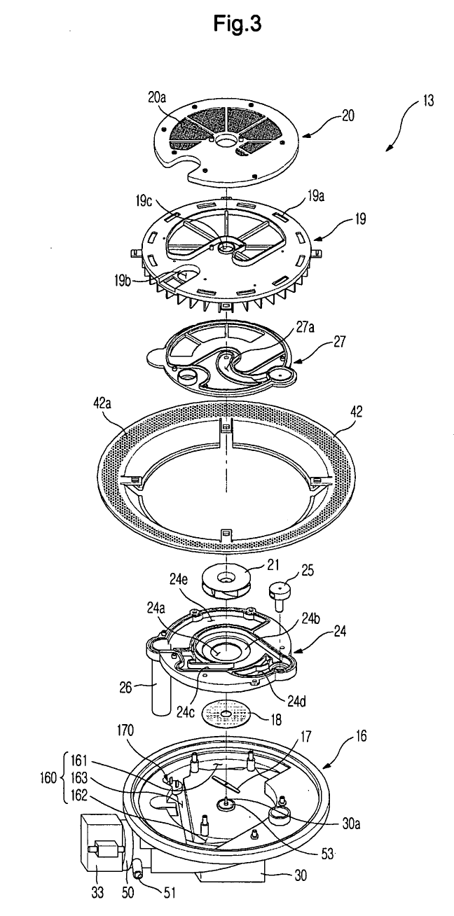

FIG. 3 illustrates the structure of the sump 13, according to an embodiment of the present invention. At one side of the sump housing 16 is disposed a pump fixing part 50, to which the drainage pump 33 is fixed. A drainage pipe 51 is connected to one side of the pump fixing part 50, through which wash water and dirt are discharged.

The pump motor 30 is mounted at a bottom of the sump housing 16, specifically, to the pump motor receiving part 300. Around the pump motor receiving part 300 is disposed a drainage channel 160, which surrounds the pump motor receiving part 300.

A rotary shaft 30a of the pump motor 30 extends through the pump motor receiving part 300. At the pump motor receiving part 300 is disposed a sealing member 53, which surrounds the rotary shaft 30a to prevent wash water from leaking to the pump motor 30.

The impeller casing 24 is disposed on the sump housing 16. In a center of the impeller casing 24 comprises a communication hole 24a, which communicates with the sump housing 16. Around the communication hole 24a is disposed an impeller receiving part 24b, in which the washing impeller 21 is received.

The washing impeller 21 is coupled with the rotary shaft 30a of the pump motor 30 such that the washing impeller 21 is rotated to pump wash water introduced into the sump housing 16 upward. A filter 18 is provided to prevent large amounts of dirt from being flowed in the washing impeller 21.

The impeller casing 24 comprises a main channel 24c and a sub channel 24d, which diverge from the impeller receiving part 24b. The main channel 24c serves to guide wash water to the main nozzles 10a and 10b (see FIG. 1). The sub channel 24d serves to guide wash water to the sub nozzle 10c (see FIG. 1).

The main channel 24c serves as a primary channel to guide the flow of wash water in the sump 13. Consequently, wash water constantly passes along the main channel 24c during the washing operation of the dish washing machine.

Thus, the main channel 24c extends from the impeller receiving part 24a in a shape of a curve to prevent drop of the injection pressure of wash water flowing along the main channel 24c.

When the main channel 24c is sharply bent, wash water collides with the sharply bent part of the main channel 24c with the result that kinetic energy of the wash water is lost. Consequently, the main channel 24c is formed in the shape of a curve to minimize the loss of kinetic energy.

A channel control valve 25 is rotatably mounted in the sub channel 24d to intermit the flow of wash water to the sub channel 24d. When the quantity of dishes to be washed is small, the sub channel 24d is closed by the channel control valve 25 such that wash water can flow only to the main channel 24c.

Wash water flowing along the main channel 24c is injected through the main nozzles 10a and 10b (see FIG. 1) to wash dishes. Consequently, the amount of wash water used is reduced when the quantity of dishes to be washed is small.

A filth chamber 24e is formed beside the main channel 24c to collect dirt introduced into the main channel 24c together with wash water. Adjacent to an inlet of the filth chamber 24e is mounted a drainage connection pipe 26, which is connected with the drainage pump 33. When the drainage pump 33 is operated, dirt collected in the filth chamber 24e is discharged to the drainage pipe 51 through the drainage connection pipe 26.

According to an embodiment of the present invention, the main channel 24c, the sub channel 24d, and the filth chamber 24e are formed at the impeller casing 24.

The impeller casing cover 27 is disposed on the impeller casing 24. At the impeller casing cover 27 is formed a guide channel 27a, which communicates with the sub channel 24d. The guide channel 27a extends from the edge of the impeller casing cover 27 to a center of the impeller casing cover 27 in a shape of a curve.

Consequently, when the sub channel 24d is opened by the channel control valve 25, wash water pumped by the washing impeller 21 passes through the channel control valve 25, and flows along the sub channel 24d. At this time, the wash water is guided to the sub nozzle 10c (see FIG. 1) along the guide channel 27a, which communicates with the sub channel 24d, and is then injected through the sub nozzle 10c.

The sump cover 19 is disposed on the impeller casing cover 27. In the center of the sump cover 19 is formed an engaging hole 19c, in which the lower end of the sub nozzle 10c (see FIG. 1) is engaged. The inlet holes 19a, through which wash water is introduced, are formed along the edge of the sump cover 19 such that the inlet holes 19a are arranged in regular intervals.

In the sump cover 19 is formed a connection hole 19b, through which the feeding pipe 11 (see FIG. 2) extends to the main channel 24c.

The filter cover 20 is disposed on the sump cover 19. The mesh filter 20a is mounted to the filter cover 20. The mesh filter 20a covers an upper surface of the filth chamber 24e to prevent dirt collected in the filth chamber 24e from passing through the mesh filter 20a together with wash water.

Specifically, when dirt and wash water are introduced into the filth chamber 24e, the wash water passes through the mesh filter 20a. However, the dirt is filtered by the mesh filter 20a and is left in the filth chamber 24e.

The wash water separated from the dirt is introduced into the sump 13 through the inlet holes 19a, and is then continuously circulated through the above-described course.

The heater 36 (see FIG. 2) and the heater cover 42 are disposed at the edge of the sump 13 such that the heater 36 and the heater cover 42 surround the edge of the sump 13.

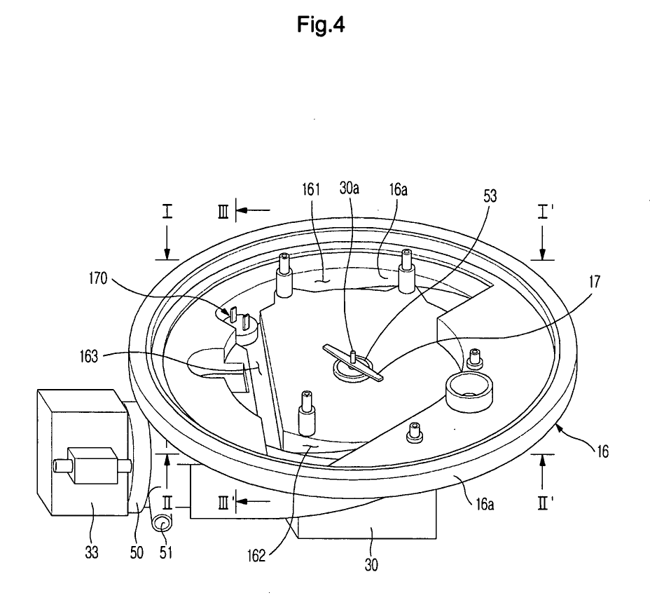

As shown in FIG. 4, the drainage channel 160 comprises first and second drainage channels 161 and 162 formed around the pump motor receiving part 300 and a third drainage channel 163 connected between the first and second drainage channels 161 and 162. The third drainage channel 163 communicates with the drainage pump 33.

Specifically, the first and second drainage channels 161 and 162 are disposed between the pump motor receiving part 300 and a rim wall 16a of the sump housing 16.

The bottom surfaces of the first and second drainage channels 161 and 162 are inclined downward to the third drainage channel 163.

The top surface of the pump motor receiving part 300 is located above the bottom surface of the drainage channel 160.

The rotary shaft 30a of the pump motor 30 extends through a top of the pump motor receiving part 300. To the rotary shaft 30a is mounted a cutter 17 to crush filth contained in wash water.

Between the first drainage channel 161 and the third drainage channel 163 is disposed a turbidity sensor 170 to detect the turbidity of wash water.

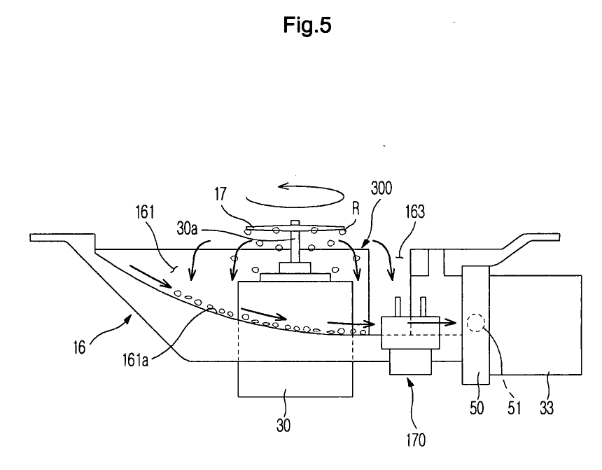

Hereinafter, the function of the drainage channel will be described with reference to FIGS. 5-7.

FIG. 5 is a sectional view taken along line I-I′ of FIG. 4. In the case that dirt R is accumulated in the first drainage channel 161 while the dirt R is crushed by the cutter 17 or is not crushed, the dirt R is moved along the first drainage channel 161 and the third drainage channel 163, and is discharged through the drainage pipe 51 by an operation of the drainage pump 33.

At this time, the dirt R is easily moved toward the drainage pump 33 since the bottom surface 161a of the first drainage channel 161 is inclined downward to the third drainage channel 163.

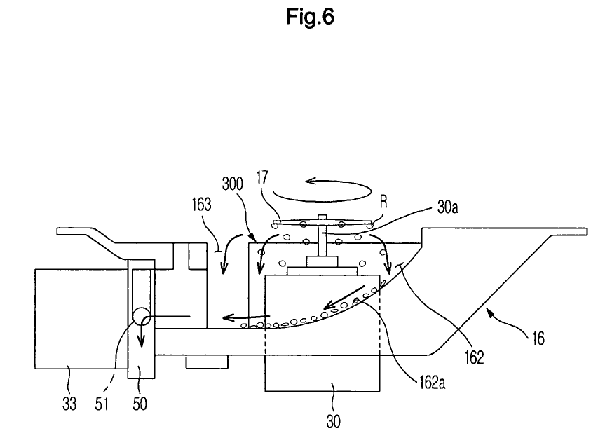

FIG. 6 is a sectional view taken along line II-II′ of FIG. 4. The second drainage channel 162 is opposite to the first drainage channel 161. The second drainage channel 162 also communicates with the third drainage channel 163.

Since a bottom surface 162a of the second drainage channel 162 is also inclined downward to the third drainage channel 163, dirt accumulated in the second drainage channel 162 is moved along the bottom surface 162a, is guided along the third drainage channel 163, and is then discharged through the drainage pipe 51 by the operation of the drainage pump 33.

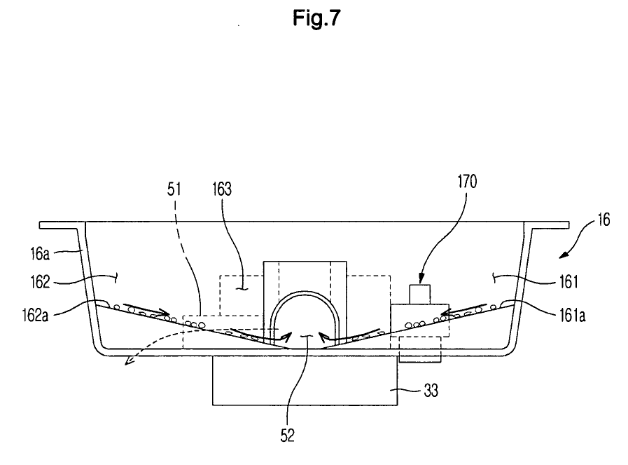

FIG. 7 is a sectional view taken along line III-III′ of FIG. 4. The third drainage channel 163 is connected between the first drainage channel 161 and the second drainage channel 162. The bottom surfaces 161a and 162a of the first and second drainage channels 161 and 162 are inclined downward to the third drainage channel 163.

In a center of the third drainage channel 163 is formed a drainage pump connection hole 52, which communicates with the drainage pump 33. When the drainage pump 33 is operated, dirt accumulated in the respective drainage channels 161, 162, and 163 passes through the drainage pump connection hole 52, and is then discharged through the drainage pipe 51.

Hereinafter, the operation of the sump will be described with reference to the accompanying drawings.

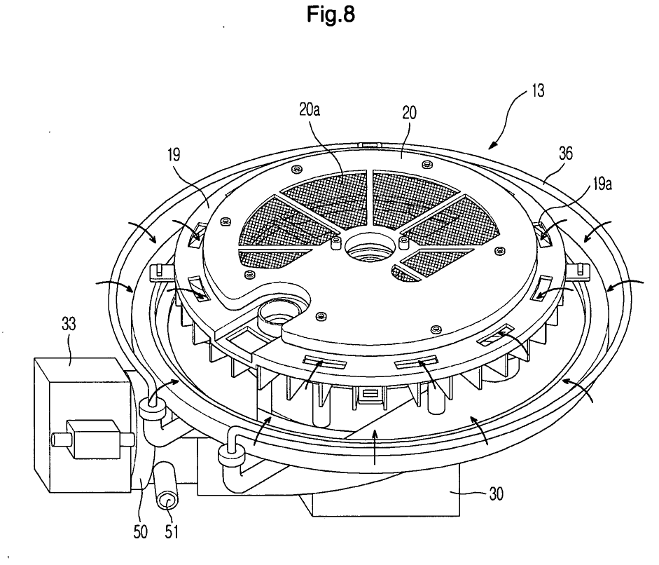

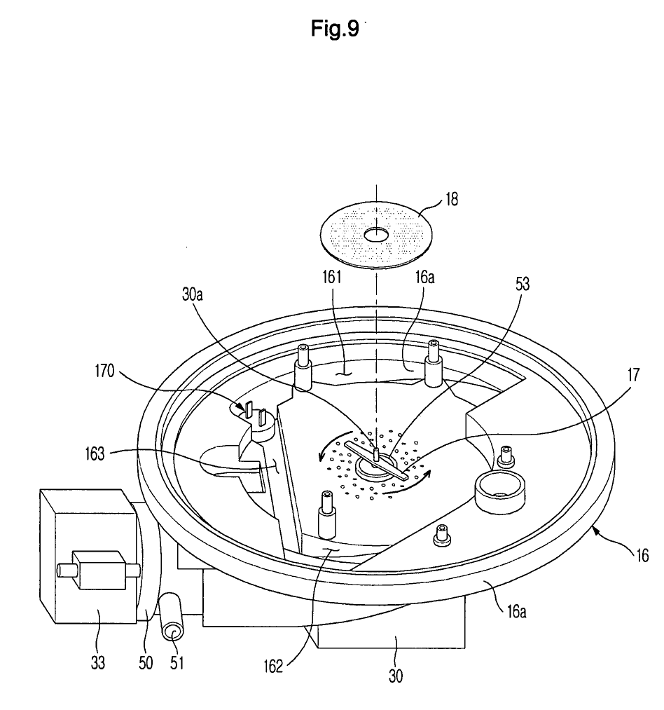

As shown in FIG. 8, wash water is heated by the heater 36, and is then introduced into the sump 13. As shown in FIG. 9, dirt R introduced together with wash water is accumulated in the drainage channels 161, 162, and 163 while the dirt R is crushed by the cutter 17 or not crushed.

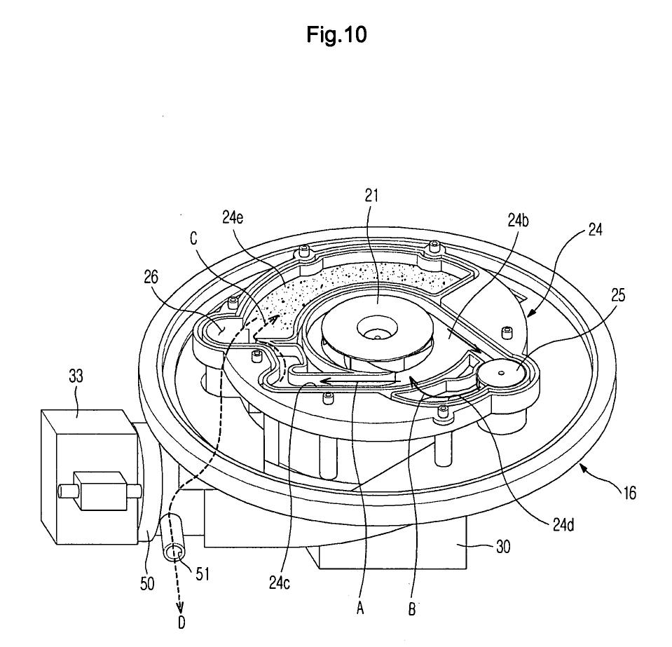

As shown in FIG. 10, the wash water received in the sump housing 16 is pumped upward to the impeller casing 24 as the washing impeller 21 mounted to the rotary shaft 30a is rotated.

The pumped wash water is moved from the impeller receiving part 24b to the main channel 24c (in the direction indicated by arrow ‘A’) and the sub channel 24d (in the direction indicated by arrow ‘B’) due to the rotating force of the washing impeller 21. When the sub channel 24d is closed by the channel control valve 25, the wash water is moved only to the main channel 24c.

The wash water flowing along the main channel 24c in the direction indicated by arrow ‘A’ is raised through the feeding pipe 11 (see FIG. 2), due to a strong pressure of the washing impeller 21, and then reaches the main nozzles 10a and 10b (see FIG. 1).

When the quantity of dishes to be washed is small, and therefore, it is necessary to operate only the main nozzles 10a and 10b (see FIG. 1), the sub channel 24d is closed by the channel control valve 25. As a result, wash water flows along only the main channel 24c. The wash water flowing along the main channel 24c reaches the main nozzles 10a and 10b through the feeding pipe 11, and is then injected through the main nozzles 10a and 10b.

When the quantity of dishes to be washed is large, and therefore, it is necessary to operate the sub nozzle 10c (see FIG. 1) as well as the main nozzles 10a and 10b, the sub channel 24d is opened by the channel control valve 25. As a result, wash water flows in the direction indicated by arrow ‘B’. Subsequently, the wash water reaches the sub nozzle 10c, and is then injected through the sub nozzle 10c.

The filth chamber 24e is connected to the main channel 24c. Consequently, dirt mixed with some wash water is moved (in the direction indicated by arrow ‘C’), and is then collected in the filth chamber 24e.

The drainage connection pipe 26 connected with the drainage pump 33 is adjacent to an inlet of the filth chamber 24e. Consequently, the dirt collected in the filth chamber 24e is discharged to the outside (in the direction indicated by arrow ‘D’) during the operation of the drainage pump 33.

When the drainage pump 33 is operated, not only the dirt accumulated in the filth chamber 24e but also the dirt accumulated in the drainage channels 161, 162, and 163 (see FIG. 9) are discharged to the outside together with contaminated wash water.

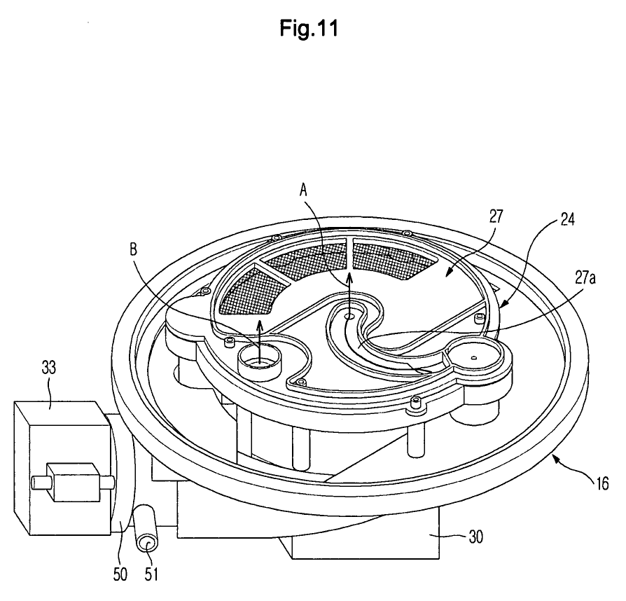

As shown in FIG. 11, the guide channel 27a is formed at the impeller casing cover 27 disposed on the impeller casing 24 such that the guide channel 27a communicates with the sub channel 24d (see FIG. 10)

When the washing impeller 21 (see FIG. 10) is operated in the state that the sub channel 24d is opened by the channel control valve 25 (see FIG. 10), wash water also flows along the sub channel 24d. The wash water flowing along the sub channel 24d is guided to a center of the impeller casing cover 27 along the guide channel 27a, is moved to the sub nozzle 10c (see FIG. 1) in the direction indicated by arrow ‘A’, and is injected through the sub nozzle 10c.

Arrow ‘B’ indicates the flow direction of the wash water flowing to the main nozzles 10a and 10b (see FIG. 1).

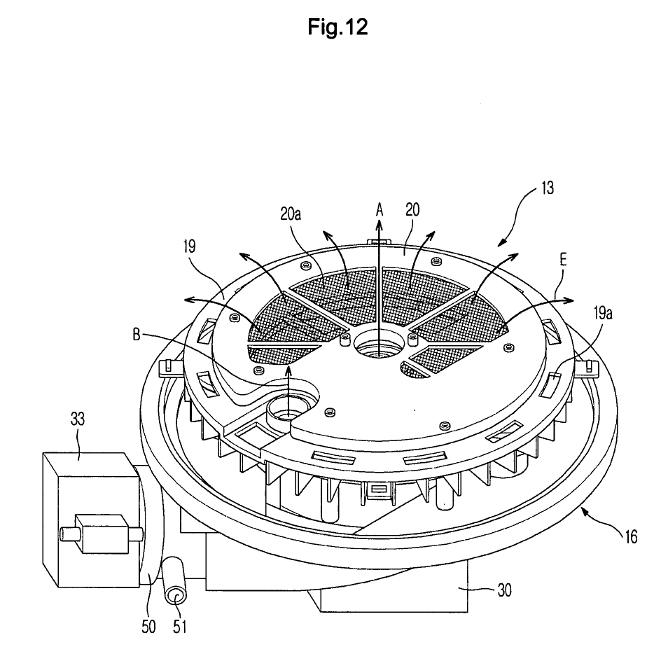

As shown in FIG. 12, wash water and dirt introduced into the filth chamber 24e (see FIG. 10) along the main channel 24c (see FIG. 10) are pushed toward the mesh filter 20a due to the pressure of subsequent wash water. However, the dirt does not pass through the mesh filter 20a. Consequently, the dirt is left in the filth chamber 24e (see FIG. 10). Only the wash water passes through the mesh filter 20a in the direction indicated by arrow ‘E’, and is then discharged out of the sump 13.

The discharged wash water is reintroduced into the sump 13, and flows inside the sump 13 to perform the washing operation as previously described.

According to an embodiment of the present invention, the drainage channels are formed in the sump housing, and some of the drainage channels are constructed such that the bottom surfaces of the drainage channels are inclined. As a result, it is possible to rapidly discharge filth contained in wash water out of the sump during the drainage of the wash water.

Consequently, the present invention has the effect of preventing the emission of bad smells from filth and preventing the propagation of bacteria.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A dish washing machine comprising:
a sump to receive and pump wash water;
a sump housing forming an external appearance of the sump;
a drainage pump coupled with the sump housing to discharge wash water and dirt; and
a drainage channel disposed in the sump housing to guide wash water and dirt to the drainage pump.

2. The dish washing machine according to claim 1, wherein the drainage channel is inclined along an inner edge of the sump housing and communicates with the drainage pump.

3. The dish washing machine according to claim 1, wherein
the sump housing comprises a pump motor receiving part to receive a pump motor to drive a washing impeller that pumps wash water, and
the drainage channel comprises first and second drainage channels formed around the pump motor receiving part and a third drainage channel connected between the first and second drainage channels, the third drainage channel communicating with the drainage pump.

4. The dish washing machine according to claim 3, wherein the first and second drainage channels comprise surfaces inclined downward to the third drainage channel such that drainage is smoothly performed along the downwardly inclined surfaces.

5. The dish washing machine according to claim 3, wherein a bottom surface of the drainage channel is lower than a top surface of the pump motor receiving part.

6. The dish washing machine according to claim 3, wherein
the sump housing is formed in a shape of a container,
the pump motor receiving part is disposed in a center of the sump housing,
the drainage channel is disposed between the pump motor receiving part and a rim wall of the sump housing, and
the drainage channel is located below a top surface of the pump motor receiving part in a shape surrounding the pump motor receiving part.

7. The dish washing machine according to claim 3, wherein the drainage channel comprises a turbidity sensor to detect the turbidity of wash water.

8. A dish washing machine comprising:
a sump to receive and pump wash water;
a sump housing forming an external appearance of the sump;
a drainage pump mounted at the sump housing to discharge wash water and dirt from the sump housing; and
a drainage channel communicating with the drainage pump to guide wash water and dirt to the drainage pump, wherein
the drainage channel extends along an inner edge of the sump housing.

9. The dish washing machine according to claim 8, wherein
the sump housing comprises a pump motor receiving part to receive a pump motor to drive a washing impeller that pumps wash water, and
the drainage channel comprises first and second drainage channels surrounding an edge of the pump motor receiving part and a third drainage channel connected between the first and second drainage channels and communicating with the drainage pump, the first and second drainage channels having surfaces inclined downward to the third drainage channel such that drainage is smoothly performed along the downwardly inclined surfaces.

10. The dish washing machine according to claim 9, wherein the third drainage channel comprises a drainage pump connection hole connected with the drainage pump wherein dirt accumulated in the respective drainage channels passes through the drainage pump connection hole, and is then discharged through a drainage pipe.

11. A dish washing machine comprising:
a washing tub to wash dishes therein;
nozzles to inject wash water into the washing tub;
a sump mounted in a bottom of the washing tub to receive, pump and supply wash water to the respective nozzles and comprising a sump housing forming an external appearance of the sump; and
a drainage channel integrally formed with the sump housing to guide wash water and dirt discharged from the sump housing.

12. The dish washing machine of claim 11, further comprising a drainage pump mounted to a side of the sump housing to discharge wash water and dirt in the sump to an outside of the dish washing machine.

13. The dish washing machine of claim 12, further comprising:
a heater mounted to an edge of the sump to heat wash water;
a heater receiving groove formed at a bottom of the washing tub and extending along an edge of the sump such that the heater is received in the heater receiving groove; and
a heater cover to cover the heater.

14. The dish washing machine of claim 12, wherein the sump further comprises:
a sump cover to cover the sump housing;
a washing impeller disposed in the sump housing to pump wash water;
an impeller casing disposed on the sump housing and comprising a main channel and a sub channel to guide wash water to the respective nozzles, and a communication hole which communicates with the sump housing.

15. The dish washing machine of claim 14, wherein the sump housing further comprises a pump motor receiving part disposed at a bottom of the sump housing and receiving a pump motor to drive the washing impeller.

16. The dish washing machine of claim 15, wherein the main channel is a primary channel to guide a flow of wash water to the sump such that wash water constantly passes along the main channel during a washing operation of the washing machine.

17. The dish washing machine of claim 16, wherein the main channel extends in a shape of a curve to prevent a drop of an injection pressure of wash water flowing along the main channel.

18. The dish washing machine of claim 17, wherein the sub channel comprises a channel control valve rotatably mounted therein to intermit the flow of wash water to the sub channel, wherein when a quantity of dishes to be washed is small, the sub channel is closed by the channel control valve and the wash water only flows to the main channel.

19. The dish washing machine of claim 14, further comprising:
a filth chamber formed beside the main channel to collect dirt introduced into the main channel together with wash water; and
a drainage pipe mounted adjacent to an inlet of the filth chamber and connected with the drainage pump, wherein when the drainage pump is operated, dirt collected in the filth chamber is discharged to the drainage pipe through the drainage connection pipe.

20. The dish washing machine of claim 19, further comprising:
a filter cover mounted on the sump cover, and a mesh filter mounted to the filter cover to prevent dirt collected in the filth chamber from overflowing from the filth chamber and to allow only wash water to flow out of the filth chamber.

21. The dish washing machine of claim 19, further comprising an impeller casing cover disposed on the impeller casing and comprising a guide channel which communicates with the sub channel, wherein the guide channel extends from an edge of the impeller casing cover to a center of the impeller casing cover in a shape of a curve.

22. The dish washing machine of claim 21, wherein the drainage channel comprises first and second drainage channels formed around the pump motor receiving part and a third drainage channel connected between the first and second drainage channels and the third drainage channel communicated with the drainage pump, wherein bottom surfaces of the first and second drainage channels are inclined downwardly to the third drainage channel.

23. The dish washing machine of claim 22, wherein the third drainage channel comprises a drainage pump connection hole which communicates with the drainage pump, wherein when the drainage pump is operated, dirt accumulated in the respective drainage channels passes through the drainage pump connection hole and is then discharged through the drainage pipe.
